(19) United States
(12) Patent Application Publication
(10) Pub. No.: US 2026/0148455 A1
(43) Pub. Date: May 28, 2026

(54) AI-ENABLED DIGITAL CANVAS FOR IMAGE CREATION AND DISPLAY

(71) Applicants: Jeremey White, Miami, FL (US); Payton Parr, Jersey City, NJ (US)

(72) Inventors: Jeremey White, Miami, FL (US); Payton Parr, Jersey City, NJ (US)

(21) Appl. No.: 19/455,754

(22) Filed: Jan. 21, 2026

Related U.S. Application Data
(63) Continuation-in-part of application No. 18/674,878, filed on May 26, 2024, now abandoned.
(60) Provisional application No. 63/502,675, filed on May 17, 2023.

(51) Int. Cl. G06T 11/60; G06F 3/0488; G06F 3/16; G06T 5/50

(52) U.S. Cl. CPC G06T 11/60; G06F 3/0488; G06F 3/167; G06T 5/50; G06T 2210/12

(57) ABSTRACT

A method and system for editing digital video and still images using a touch-sensitive display and voice input, and for storing and displaying the digital video and images, are described. Digital videos may be animated and/or interactive. The process involves identifying a bounded area of an image based upon a user's voice or touch input, and receiving a text or voice input to describe a desired modification. Voice inputs are converted into text prompts, and a generative AI model is used to create a replacement image segment based upon the prompts, which is then merged with the original image to produce a composite edited image. The system includes a processor, memory, and connectivity options, supporting third-party applications and over-the-air updates for the AI model. A Trusted Platform Module stores keys for securely encrypting stored artworks and locking them to the system's hardware, preventing unauthorized transfer to other devices.

### CROSS-REFERENCE TO RELATED APPLICATIONS

This application is a continuation-in-part of U.S. patent application Ser. No. 18/674,878 filed on May 26, 2024, which claims benefit of U.S. Provisional Application No. 63/502,675 filed on May 17, 2023, the entire contents of both of which are hereby incorporated by reference.

### TECHNICAL FIELD OF THE INVENTION

The invention is in the field of processor-equipped touch screens for creating and displaying artwork. More specifically, the invention relates to AI-powered digital art frames and methods of use thereof, and in particular to a dedicated hardware device for generating, editing, storing and displaying original digital artwork through an intuitive, interactive user interface.

### BACKGROUND

Advances in the speed and power of digital processors have given graphic artists increasingly powerful digital tools for the creation and editing of artistic images on display screens rather than on traditional media such as paper and canvas. Many artists are using digital software and tools to draw, color, model, and manipulate images, in styles ranging from digital photography and digital painting, to 3-D modeling and digital sculpture, to “generative” art created with the aid of artificial intelligence (AI). Digital art has become an increasingly significant component of the contemporary art world, driven by advancements in technology and the growing accessibility of digital tools. Artists are leveraging software and hardware to produce innovative works that challenge traditional notions of art. The application of artificial intelligence (AI) to this domain has opened new avenues for creativity, allowing for the generation of unique and complex artworks that were previously unimaginable. AI generative models, such as generative adversarial networks (GANs) and diffusion models, have become instrumental in creating original art that is reflective of the artist's vision.

Current solutions for digital art creation often involve complex software applications that have a steep learning curve and require technical expertise. Existing digital art tools, such as graphic design software and drawing tablets, are becoming increasingly powerful, but can be cumbersome and unintuitive for users who are not familiar with their interfaces. These tools typically rely on manual input methods, such as a mouse or touchscreen, which can limit the artist's ability to make precise and expressive modifications. Additionally, the process of editing digital art often involves multiple steps operating on multiple image layers, and multiple software applications, making it a time-consuming and fragmented process.

As digital art continues to evolve, the need for intuitive and efficient tools to create, edit, and display these works has become increasingly apparent.

With the appropriate software, it is possible to identify entire image elements, such as foreground or background objects, and remove, relocate, replace and/or edit them with written or even spoken natural-language prompts. (See, e.g., S. P. Sietzen et al., U.S. Pat. No. 12,361,619; and T. H. Bui et al., U.S. Pat. Application publication No. 2020/0042286.)

Hardware options for the latter class of digital art creation are limited to general-purpose computers powerful enough to run both the AI applications and the graphics software. The processor must manipulate large, high-resolution images with sufficient speed to satisfy an artist's need for real-time display of the work in progress, preferably on a large high-resolution monitor. General-purpose computers with the required speed, memory, and storage remain costly.

In the realm of digital art ownership, means for the commercial sale of digital art range from the traditional sale of copyrights or copyright licenses to, more recently, non-fungible tokens (NFTs), which have emerged as a popular method for buying, selling, and owning digital art. NFTs are unique digital identifiers of artworks that are recorded on a blockchain and can used to certify both ownership and authenticity. Because the ownership of an NFT is recorded in a blockchain, it can be transferred by its owner to another party, which allows NFTs to be sold and traded online or at auction. However, NFTs present their own set of challenges, due to the abstract nature of ownership.

Unlike physical art pieces, NFTs are digital certificates that represent ownership of a digital asset, in a manner analogous to a deed or title to real or personal property. NFTs do not necessarily grant copyright or other exclusive intellectual property rights in the underlying artwork, and an NFT by itself cannot physically prevent others from copying and sharing the digital file it represents: it does not guarantee or represent physical possession of the artwork itself. This disconnect can be a barrier for collectors who value the physical presence of art and the provable authenticity of the artist's work. Digital art conveyed via an NFT may not involve the transfer of a physical object to which the artwork is tied.

There is a need for a more integrated and user-friendly approach to digital art creation and ownership. A solution that enables intuitive interaction, by both creators and collectors, with a tangible representation of digital art would address the limitations of current tools and ownership models. There is a need for a digital canvas upon which an artist can create digital graphical art, and upon which a buyer or gallery visitor can view and, optionally, interact with the artwork. There is also a need for a digital canvas that is relatively inexpensive and can be physically tied to the artwork itself.

### BRIEF DESCRIPTION OF THE INVENTION

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages over the prior art.

The invention, broadly, is an improved and more capable version of processor-equipped touch screens (e.g., tablet computers) for creating and displaying artwork. One aspect of the invention is the provision of a computer-implemented method for creating and editing digital images. The method generally includes receiving a touch input on a touch-sensitive display, wherein the touch input identifies a region of the display or a region of a displayed image which the user wishes to edit. The method generally includes receiving a voice input via an audio input device, wherein the voice input describes a desired image or desired modification for the identified region of the image. The method generally includes converting the voice input into a text prompt using a speech recognition component. The method generally includes identifying a bounded area of the displayed image corresponding to the touch input using an image region selection component. The method generally includes generating an original image or a replacement image segment for the bounded area using a generative AI model based on the text prompt. The method generally includes merging the replacement image segment with the displayed image to produce a composite edited image. The method generally includes displaying the composite edited image on the touch-sensitive display.

Another aspect of the invention is the provision of a substantially self-contained device (a “digital canvas”) that is specifically configured to enable the above-described methods. The device is an integrated system of task-specific software and hardware components. The system generally includes a touch-sensitive display configured to create and display an image and to receive touch inputs that identify a bounded portion of the displayed image. The system is preferably equipped with an audio input device, configured to receive spoken input describing a desired image or desired modification to the identified region of the image. The system generally includes a processor and a memory storing instructions that, when executed by the processor, cause the system to convert the voice input into an executable prompt using a speech recognition software component. An image region selection component of the software identifies a bounded area of the displayed image corresponding to the touch input or a voice input. The system employs a generative AI model to create a replacement image segment for the bounded area, based upon the received prompt. The generative AI model may present the user with preset artistic styles to choose from when creating or modifying an image. The system generally includes merging the replacement image segment with the displayed image to produce a composite edited image. The system then renders the composite edited image on the touch-sensitive display.

It is an aspect of the invention that the device provides a dedicated hub for a plurality of AI models that may accept various inputs (such as audio, touch, and text) and generate content and perform image editing based on the inputs. The AI models, which may be available to the public or accessible by subscription, are identified and downloaded as needed or as requested, and may be stored in the computer-readable storage medium of the device for future use. The device thereby enables the user to employ the most recent versions of a wide variety of AI models.

Another aspect of the invention is the provision of a non-transitory computer-readable storage medium. The non-transitory computer-readable storage medium generally includes instructions that, when executed by a processor, cause the processor to perform operations comprising receiving a touch input on a touch-sensitive display, wherein the touch input identifies a bounded portion of a displayed image. The non-transitory computer-readable medium generally includes instructions for receiving a spoken input from an audio input device, wherein the spoken input describes a desired image or a desired modification to the identified region of a displayed image. The non-transitory computer-readable medium generally includes instructions for converting the spoken input into an executable prompt. The non-transitory computer-readable medium generally includes instructions for drawing a new image or identifying a bounded area of the displayed image corresponding to the touch input. The non-transitory computer-readable medium generally includes instructions for generating a replacement image segment for the bounded area using a generative AI model based on the prompt. The non-transitory computer-readable medium generally includes instructions for merging the replacement image segment with the displayed image to produce a composite edited image, and instructions for causing the composite edited image to be displayed on the touch-sensitive display.

Another aspect of the invention is the provision of a method for securely fixing the artwork to the hardware system, by storing only an encrypted version of the artwork file in the device's non-transitory computer-readable storage medium. The system will thereafter require the use of an encryption key securely stored within the system to produce a displayable image of the artwork.

### BRIEF DESCRIPTION OF THE DRAWINGS

FIG. 1 outlines a method for creating and editing a digital image, according to an embodiment.

FIG. 2 is a block diagram illustrating a system for creating a digital image, according to an embodiment.

FIG. 3 is a block diagram illustrating a system for editing a digital image, according to an embodiment.

FIG. 4 is a block diagram illustrating a system for creating and editing digital images, according to an embodiment.

FIG. 5 is a block diagram illustrating an embodiment of a system for creating and editing digital images using AI generative models loaded from a server as needed.

### DETAILED DESCRIPTION OF THE INVENTION

The following detailed description is directed to certain specific embodiments of the disclosure. However, the disclosure can be embodied in a multitude of different ways. In this description, reference is made to the drawings wherein like parts are designated with like numerals throughout.

Unless the context requires otherwise, throughout this specification, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

Unless defined otherwise, all technical and scientific terms used herein have the same meaning as commonly understood by one of ordinary skill in the relevant arts.

As used herein, the term “audio input device” refers to any hardware component capable of capturing sound and converting it into an electrical or digital signal for processing by a computing system. Non-limiting examples include a microphone, a microphone array, or an external audio capture device connected to the processing system.

As used herein, the term “bounded area” refers to a specific, delimited region within a digital image or display area. The boundaries of this area are typically defined by a set of coordinates and can be represented in various forms, including but not limited to one or more bounding boxes, a polygon, a pixel mask, or a free-form shape derived from a user's touch input.

As used herein, the term “cloud service” refers to a network-accessible platform configured to provide on-demand computing services or resources, including but not limited to data storage, processing power, and access to software models, typically over the Internet.

As used herein, the term “component” or “module” refers to a unit of a software or hardware system configured to perform a specific function or set of functions. The unit may be physical, logical, virtual, distributed, or hybrid. It can be implemented in software, hardware, firmware, or any combination thereof. For example, a “speech recognition component” may be a software module that processes audio data to generate text.

As used herein, the term “composite edited image” refers to a digital image resulting from the merging of a replacement image segment with an original or previously-edited image.

As used herein, the term “coroutines” refers to a computer program component configured to temporarily suspend and then resume execution, in order to enable cooperative or non-preemptive multitasking. Coroutines may be used for managing asynchronous operations to prevent blocking of a main execution thread, thereby maintaining user interface responsiveness.

As used herein, the term “generative AI model” refers to any artificial intelligence model configured to generate new content based on patterns learned from prior data. Non-limiting examples include diffusion models, generative adversarial networks (GANs), variational autoencoders (VAEs), and large language models with image generation capabilities. Specific models include but are not limited to Runway, Veo 2/3, Open AI Gpt 3.5/4/5, Nano Banana, Claude Opus, Claude Sonnet, Claude Haiku, and Llama 3.

As used herein, the term “image database” refers to a collection of digital images stored in a manner that allows retrieval, access, or manipulation by a computer system. The database may be local to a device or hosted remotely on a cloud service, and may include metadata associated with each image, such as classification information and unique identifiers.

As used herein, the term “image generation component” refers to a software module configured to invoke a generative AI model to create a new image or a segment thereof based on one or more inputs, such as a text prompt.

As used herein, the term “image merging component” refers to a software module configured to combine two or more images or image segments into a single composite image. This may involve techniques such as alpha blending, feathering, or other algorithmic blending methods to create a seamless transition between the merged elements.

As used herein, the term “image region selection component” refers to a software module configured to identify and define a bounded area within a digital image based on one or more inputs. The inputs may be manual, such as touch-defined coordinates, automated, or AI-assisted selections.

As used herein, the term “non-transitory computer-readable medium” refers to any tangible storage medium configured to store data, or instructions for execution by a processor. Such a medium may take many forms, including but not limited to non-volatile media such as optical or magnetic disks and SSD storage devices, and temporary storage media such as random-access memory.

As used herein, the term “over-the-air (OTA) update” refers to the wireless delivery of new software, firmware, or other data to devices. This mechanism allows for the updating of system components, such as generative AI models, without requiring a physical connection.

As used herein, the term “processing system” refers to one or more processors, configured to execute instructions or process data to perform functions. A processor may be, without limitation, a central processing unit (CPU), a graphics processing unit (GPU), a microprocessor, or a digital signal processor (DSP), and may be a multi-core processor. A processing system may reside on multiple chips or in a single System on Chip (SoC).

As used herein, the term “replacement image segment” refers to a new portion of a digital image generated by a generative AI model, to replace or modify the contents of a specified bounded area of the digital image.

As used herein, the term “speech recognition component” refers to a software module configured to process audio data containing speech and convert it into a machine-compatible format, such as a text string or “text prompt.”

As used herein, the term “text prompt” refers to a sequence of text characters serving as input to a generative AI model to guide content generation or execution of an instruction. The text prompt may be in a natural language, which the AI model is capable of interpreting, or in certain embodiments may be machine-readable code.

As used herein, the term “touch input” refers to an input provided by physical interaction with a touch-sensitive display. For example, the touch input may be a tap, swipe, drag, or press. The touch input received by the system is typically registered as a set of coordinates or a gesture.

As used herein, the term “touch-sensitive display” refers to a display or surface configured to detect the presence and location of a touch or gesture. The display may optionally detect the pressure of the touch as well. This allows for direct interaction with displayed graphical elements. The touch-sensitive display may include one or more touch-sensitive regions that cover all or part of the display area.

As used herein, the term “voice input” refers to an input of audio containing speech provided to an audio input device. The voice input typically serves as a command or descriptive instruction for the system.

As used herein, the terms “Trusted Platform Module” and “TPM” refer to discrete TPM chips, and also to TPM modules integrated into processors and systems-on-chip.

### General Principles

The present disclosure relates generally to systems and methods for digital image editing, and more specifically to a dedicated digital art device and an associated computer-implemented method that leverages an intuitive, interactive user interface combining touch and voice inputs to control custom art generation through one or more generative artificial intelligence (AI) models. The disclosed systems and methods provide an integrated hardware and software solution that simplifies the creative process.

The operational concept is a multimodal interaction method where a user can directly create and/or edit a digital image displayed on a touch-sensitive screen. A user first physically touches a region of the image that the user wishes to modify. Alternately, a user can provide voice input of the desired modification. This touch input identifies the target area. Subsequently, the user provides a voice command describing the desired change (e.g., “make this a red car,” “add a starry night sky here”). This combination of localized touch input and descriptive voice input provides a natural and efficient way to direct generative AI models. The user may also provide inputs through other modes known in the art, such as text and menu selections.

At a high level, the system operates by first receiving the touch input to define a bounded area on the displayed image. It then captures the subsequent voice input via an integrated audio input device. A speech recognition component converts the audio into a text prompt. An image generation component then utilizes a generative AI model, such as a diffusion model, to generate a new replacement image segment based on the content of the text prompt and, in some embodiments, the context of the original image content within the bounded area. Finally, an image merging component integrates this newly generated segment into the original image, replacing the content within the bounded area to produce a composite edited image, which is then displayed to the user. This workflow is designed to be rapid and iterative and interactive.

The touch input provides the “where” of the edit with spatial precision, while the voice input provides the “what” with descriptive detail. The system is preferably embodied in a dedicated hardware device, such as a digital art frame, which provides the necessary components (display, processor, storage, network connectivity, microphone, etc.) and which can serve as a physical instantiation of the artwork.

### Method for Multimodal Image Creation and Editing

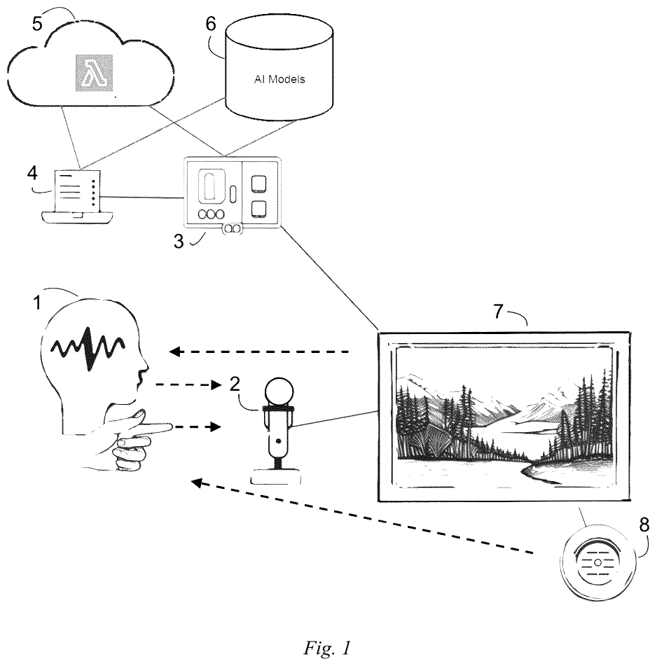

Referring to FIG. 1, a computer-implemented method for creating and editing a digital image is represented. The method allows a user to create a digital image and to modify a specific region of a digital image using a combination of at least touch and voice inputs. A human operator 1 provides inputs in the form of spoken commands to microphone 2 and touches to touch-sensitive display 7. Microphone 2 and speaker 8 are shown separately for clarity, but are preferably integrated into the housing of screen 7. On-device processor 3 executes application code stored in memory 4 to interpret the touch and voice inputs and convert them to executable instructions. The Application Code includes APIs which fetch the required generative AI and LLM models, and any needed images, from an external server 5 and from on-device storage 6. Execution of the instructions results in the generation of a composite edited image, which is displayed on screen 7 to inform the user of the results of the commands. Audible feedback, in the form of sounds or generated speech, can be provided via speaker 8. As described more fully herein, the system is designed to provide feedback as quickly as possible, to facilitate smooth and intuitive editing by the user.

The method begins when a processing system receives a touch input on a touch-sensitive display. The touch-sensitive display is configured to render a digital image, and the touch input may serve to identify the specific region of the displayed image that the user wishes to modify. The touch input can take various forms, such as a tap, a drag to draw a shape, or a circling gesture, allowing the user to directly indicate the area of interest on the image. A stylus may be used for fine resolution work, a fingertip may be used for low resolution sketching and digital painting, as well as other tools having various shapes and sizes. Preferably, the user drags to select a region of the displayed image to edit. When they let go, voice detection is initiated. The device recognizes the dragging as part an edit request. An image analysis application may be called upon to identify the borders of an object within the image that the user is pointing to.

Concurrently with or subsequent to the touch input, the processing system receives a voice input from an audio input device, such as a microphone. This voice input is a natural language command from the user identifying the region of the image the user wishes to select and/or the desired modification for the identified region. For example, “remove this tree” identifies a region by its borders (which can be deduced by image analysis at the location of the touch), and states the desired modification to the region. In some embodiments, receiving the touch input and receiving the voice input may occur sequentially, with the touch input preceding or following the voice input.

Upon receiving the voice input, a speech recognition component of the processing system processes the captured audio data to convert the voice input into a text prompt. This conversion translates the user's natural language intent into a machine-readable format. In certain embodiments, converting the voice input into the text prompt comprises processing audio data captured by a microphone that is integrated with the touch-sensitive display or its housing. Text prompts are the expected form of input for most generative AI models, but in certain embodiments of this invention, the voice input may be directly converted into machine-readable or executable code.

An image region selection component of the processing system analyzes the data from the touch input to identify a bounded area of the displayed image within which the user's editing command is to be implemented. This component translates the raw touch coordinates into a defined region for image insertion or modification. In some embodiments, the bounded area is represented as one or more bounding boxes defined by coordinates derived from the touch input.

Once the text prompt has been generated and the bounded area has been identified, an image generation component of the processing system generates a new image or modified image segment for the bounded area. This generation is performed using a generative AI model and is based on the content of the text prompt. The generative AI model, which may be a diffusion model, synthesizes a new image or new image segment that matches the description provided by the prompt.

Following the generation of the new image or replacement image segment, an image merging component of the processing system integrates the newly created segment into the original displayed image to produce a composite edited image. In some embodiments, merging the replacement image segment with the displayed image comprises algorithmically blending the replacement image segment to produce a seamless composite edited image. This can involve techniques such as alpha blending, gradient domain fusion, or Poisson image editing.

The process concludes by displaying the composite edited image on the touch-sensitive display. This provides immediate visual feedback to the user, enabling an iterative and interactive creative process. Alternately, a user may edit a displayed image by voice input only. After activating the touch-sensitive display, the user provides a voice prompt. The device then recognizes that the user has submitted an image edit request as opposed to a pure image generation request. The relevant AI model then compares the prompt to the displayed image to determine what is being asked to edit, edits the image, and returns the composite edited image. Thus, a displayed image may be edited through voice input only, or a combination of touch and voice. On every prompt, the device first transcribes the audio input and determines which of the various device functionalities, if any, most closely corresponds to the user's request. An error message appears if the audio can't be transcribed, if the generation fails for any reason (e.g., for lack of relevant functionality), or if the prompt or generation is rejected (e. g, for inappropriateness.)

In a particular embodiment, a user may launch on the device a third-party application which is designed for creating a particular style of art. For example, the user may indicate a desire to generate and/or edit an anime-style character portrait. The system makes an Application Programming Interface (API) call through the system's AI Model Loader JS Library, requesting a specialized model identified as “anime-diffusion-v3”. If the system determines that this model is not in the local cache, it initiates a download from a remote cloud server, retrieving the multi-gigabyte model file and storing it in the device's local model database. Once loaded, the model is made available to the image generation component. Subsequent voice commands from the user within this application, such as “insert [or draw] a girl with silver hair and green eyes”, are processed using this specialized model, resulting in the generation of artwork in a consistent anime style.

By default, the models will simply process the user's prompts without any stylistic enhancement, but a new user may be guided through a set of steps in order to create their own style. Users are guided to generate their custom style at the initial start-up of the device. Users may also generate additional custom styles at any point after the initial device start-up or first run. User-generated custom styles are arrived at via a process where the user is encouraged to choose from a selection of options to build their style. These selections can be saved as user preferences, and over time the combination of preferences can become a style. When a style is equipped (the user electing to make a specific style active), each image generation (set of user prompts) is altered to reflect the equipped style.

Following the creation of a composite edited image, the user has the option of issuing a “save image” command. The processing system takes the full-resolution byte data of the composite edited image and writes it to the internal image database stored in the device's memory. Upon successful completion of the write operation, the database generates and returns a unique identifier, e.g. “uuid-a1b2-c3d4-e5f6”. This identifier is stored in association with the image's metadata, including a timestamp and a thumbnail. This unique identifier allows the user to later retrieve, display, export, or perform further edits on this specific version of the artwork.

In some embodiments, the method further comprises storing the composite edited image in an image database and generating a unique identifier (e.g., a BlobID) associated with the composite edited image. This allows for unambiguous retrieval and management of each distinct image.

In preferred embodiments, the operations of converting, identifying, generating, and merging are executed asynchronously using coroutines to maintain the responsiveness of a user interface rendered on the touch-sensitive display. This allows long-running tasks to be executed in the background without blocking the main user interface thread.

The method may further comprise retrieving a generative AI model from a cloud service prior to generating the replacement image segment. This may involve dynamically loading one or more generative AI models from a remote server and storing the generative AI model(s) in a local model database.

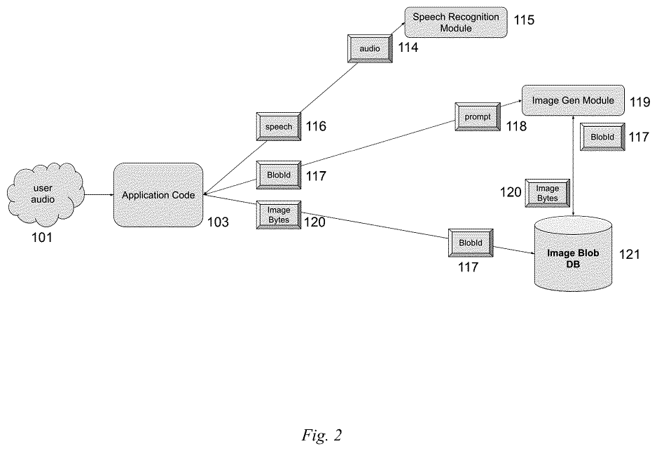

FIG. 2 shows basic elements of the image generation process. Application Code 103 is activated by the user's touch on the screen or by a push from an external source. It may also be activated by text, audio or video prompt. A voice command 101 issued by a user is initially received as an audio signal from microphone 2. Application Code 103 includes instructions that route the audio data signal 114 to the Speech Recognition Module 115. Module 115 carries out speech recognition and returns the identified speech 116 to the Application Code, which converts it to an AI model prompt 118 that can be recognized by the Image Generation Module 119. Upon receiving the prompt, Image Generation Module 119 creates an image via an appropriate generative AI model obtained from external server 5 or from on-device storage 6. The module will initially default to any user-selected image generation model. In the absence of a pre-selected model, the device prompts the user to decide on which specific model to use. The user may also elect to have the device decide on the best model to use. Certain categories of edits will automatically revert to one model, while other categories will preferentially be assigned to other models, based on an updated set of programmed preferences. The Image Bytes 120 representing the generated image are sent to the Image Blob Database 118, which stores the Image Bytes and generates a BlobID token 117 that the system can use to find and retrieve the Image Bytes in the future. Image Generation Module 119 returns the BlobID token to the Application Code 103, which uses it to retrieve and load the image bytes from the Image Blob Database, in order to display the image on the touchscreen of the device.

Alternatively, the user may tap the screen and be presented with a QR code. The user is taken by the QR code to a website where they can upload text prompts for the desired output. The device detects the submission, downloads the text, and generates content based on the he text prompts. Text prompts may also be entered via an on-screen keyboard, or via text messages transmitted to a dedicated number.

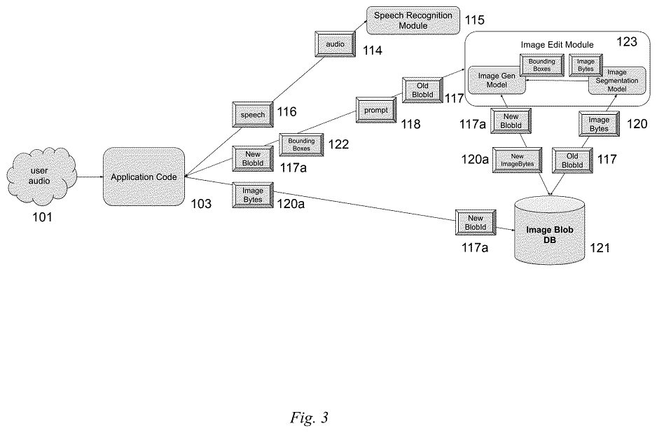

FIG. 3 shows basic elements of the image editing process. Application Code 103, if not already active, may be activated by the user's touch or touch-drag on the screen, by a voice prompt, or by a push from an external source. A voice command 101 issued by a user is initially received as an audio signal from microphone 2. Application Code 103 includes instructions that route the audio data signal 114 to the Speech Recognition Module 115. Module 115 carries out speech recognition and returns the identified speech 116 to the Application Code, which converts it to an AI model prompt 118 that can be recognized by the Image Generation Module 119. The prompt 118, the BlobID of the user-requested or currently displayed image (the “Old BlobID) 117 are then sent to Image Edit Module 123. Image Edit Module 123 loads the “old” image bytes 120 of the user-requested or currently displayed image. An Image Segmentation Model generates bounding boxes 122 based on the prompt, the drag location information (if any), and the old image bytes, and sends the bounding boxes and old image bytes to the Image Generation Model. The Image Generation Model generates new image bytes 120a from the old image bytes 120, based on the prompt and bounding boxes. The new image bytes 120a are stored in the Image Blob DB, and a new BlobID 117a is generated. The bounding boxes 122 and new Image BlobID 117a are sent to the Application Code 103, which uses them to retrieve and load the new image bytes 120a from the Image Blob Database 121, in order to display the edited image on the touchscreen of the device.

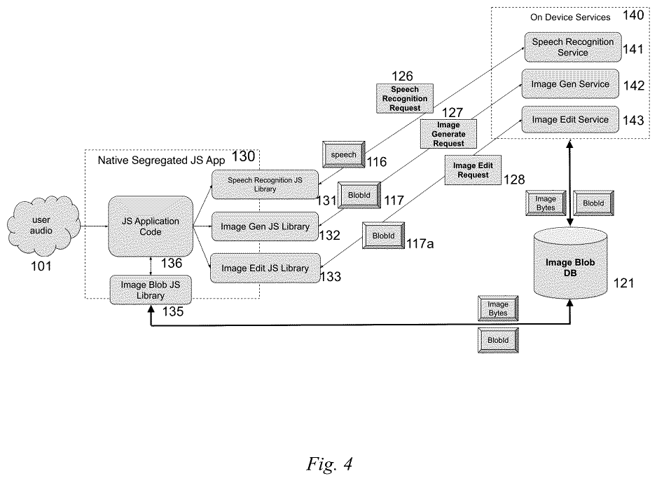

FIG. 4 shows how Segregated On Device Applications (apps) Interact with On Device AI-Backed Services. The device receives user audio via the on-device microphone 2 after a user touch, or via a push from an external source to the on-device server. The audio is passed to a segregated Native JavaScript (JS) Application 130. The Application 130 passes the audio to the Speech Recognition JS Library 131, which sends the audio to the on-device Speech Recognition Service 141 along with a Speech Recognition Request 126. (The On Device Services 140 are exposed to segregated applications as services on the device.) The Speech Recognition Service 141 sends back the detected speech 116. The Application 130 receives the speech via the Speech Recognition JS Library 131 as an intermediary, converts the speech into an AI model prompt, and sends it to the Image Generation JS Library 132. Any text received via a push from an external source is likewise sent as an AI model prompt. The Image Gen JS Library 132 sends the prompt to the on-device Image Gen Service 142 along with an Image Generate Request 127. The Image Gen Service generates an image based on the prompt, stores the image bytes to Image Blob data base 121, and sends back the identifying image BlobID 117.

The Application 130 receives image BlobID 117 via the Image Gen JS Library 132 as an intermediary, reuses the original prompt as an edit prompt, and sends the image BlobID 117 and prompt to the Image Edit JS Library 133. The Image Edit JS Library 133 then sends the image BlobID 117 and edit prompt to the on-device Image Edit Service 143 along with an Image Edit Request 128. The Image Edit Service 143 sends the original image BlobID 117 to Image Blob DB 121, which returns the image bytes representing the original image.

Image Edit Service 143 edits the image according to the edit prompt, stores the new image bytes in the Image Blob DB, and sends a new BlobID 117a identifying the edited image bytes to Image Edit JS Library 133, which passes it to the application 130. Via Image Blob Js Library 135, the application sends the edited image's BlobID 117a to Image Blob DB 121, which returns the edited image's image bytes to the to the application 130 via the Image Blob JS Library 135. The application 130 then displays the edited image on the screen of the device.

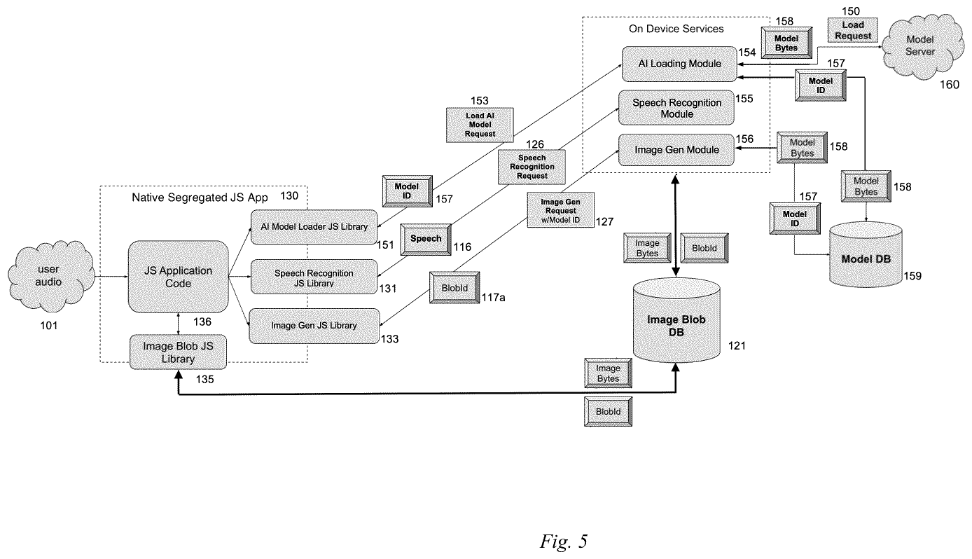

FIG. 5 shows the process by which the Segregated Application 130 Loads a New generative AI Model. The application requests a new AI model to be loaded via an AI Model Loader Javascript (JS) Library. The AI Model Loader JS Library 151 requests an AI model to be loaded from the AI Loading Module 154, which in turn loads an AI model from external model server 160. The AI Loading Module stores the model bytes 158 to Model Database 159, and receives an identifying Model ID 157. The AI Loading Module 154 then passes the Model ID back to the application 130 via the AI Model Loader JS Library 151. As described above, the device receives user audio 101 via the on-device microphone or via text pushed from an external source, and sends the audio via the Speech Recognition JS Library 131 to the Speech Recognition Module 155, from which it receives the recognized speech. The Application Code converts the speech into an AI model prompt, which is sent to the Image Generation JS Library 133. The Image Generation JS Library packages the prompt and the previously-loaded model ID into a request object 127, and sends the request to the Image Generation Module 156.

The Image Generation Module sends the Model ID 157 to the Model DB 159, and in response receives the model bytes 158 identified by the Model ID. Based on the prompt, the Image Generation Module 156 generates an image using the model bytes 158, and stores the resulting new image bytes in the Image Blob DB 121, receiving in return a BlobID token identifying the new image bytes. The Image Generation Module returns that BlobID to the Application via the Image Generation JS Library 133. The application sends the BlobID to the Image Blob DB, receiving in return the new image bytes. The application then causes the corresponding new image to be displayed on the screen of the device.

In addition to generating and editing static images, the methods and system of the invention are capable of generating animated images. The process is fundamentally similar: user prompts are obtained via audio input and speech recognition. The user may supply (or generate via the system) a static image to be used as the initial frame. Based upon the spoken prompts and any initial frame provided, a generative AI video model will generate an animated video using a video- or animation-specific generative AI video model, such as Veo 3 or Runway Gen-r Turbo.

More complex animations may generate video from the same types of inputs, but with a more complex process. For example, after receiving audio input and converting it to text, an AI language model may attempt to determine the user's overall intent, create a plan of action involving generating one or more videos, images, or 3D models (with or without audio), combining them using an internal video editing tool suite, and then return the generated output for the user to review and refine his or her prompts. For repetitive tasks, users may save ordered sets of instructions and prompts as custom JS services, that can subsequently be called up by themselves or by other users.

To generate a new or edited video, the user may touch the screen and speak to generate a new video or initiate an edit. Alternatively, the user may tap the screen and be presented with a QR code. The user is taken by the QR code to a website where they can upload a video, still image, and/or text prompts for the desired output. The device detects the submission, downloads the video or image, and generates content based on the video and the text prompts. The generated content may take the form of edits to the video, or be new content based on the video (such as images based on frames in the video, new video with scenery or characters found in the source video or image, etc.) In some embodiments, the generated content may be made available to the user (e.g., via a QR code) for download to the user's device.

The system also enables the generation of interactive media, for use in museums, galleries, classrooms, and the like. A user may request an educational video, in a desired style and format, and the system can generate an animated video based on an existing or newly generated or displayed image or other content. A user may interact with the system with follow-up questions that may be answered by voice, or by touching the screen to select from multiple-choice answers or to select objects in the displayed image or by asking open-ended questions. A user may upload a document, e.g., a brochure of Things to Do in Manhattan, and the system can create a walking tour video based on the contents of the uploaded document. The system may be programmed to create conversational avatars of a user in real-time. Such requests are within the capabilities of generative AI models such as Veo-3.

### SYSTEM ARCHITECTURE

In preferred embodiments, the system is a self-contained special-purpose device that functions as a dedicated system for creating and editing digital images. The device incorporates processors, computer-readable storage, dynamic memory and buffers, and audio input and networking hardware, along with a touch-screen display. As the invention is a dedicated system and device specifically designed to carry out the methods of the invention, the full capabilities of a general-purpose computer are not present. Users do not have access to the underlying file system or mounted storage during normal operation, as the generated content and edits are managed internally by the application. Preferred embodiments of the device are fully secured against exposing general system functionality. Third-party applications may be executed through a JavaScript execution environment, but there is no provision for the installation of third-party software by the user. The device is configured to automatically enter the image creation/editing environment on boot, and to recover to a known safe interaction state after abnormal termination, thereby maintaining continuous appliance-like operation. Printer drivers and printer-specific hardware, for example, may be omitted from the preferred embodiments. Connectivity can be limited to network connections, such as Wi-Fi or Ethernet. Support for telephony, audio editing, and peripheral devices (e.g., cameras, mice, keyboards, external displays, external storage devices, etc.) may be limited or missing, and the circuitry and hardware for video and I/O ports such as VGA, HDMI, USB, Firewire, Lightning, Serial, Parallel, PS/, and the like, are preferably absent.

The system includes a touch-sensitive display, configured to display the digital image being created and edited and to receive the touch input that identifies a region for the generated new image or a region of the displayed image which is to be edited. By way of example, a 32-inch or larger In-Plane Switching (IPS) touchscreen, having a resolution of 1920×1080 pixels or more, is suitable for use in the invention.

The system further comprises an audio input device, configured to capture voice input from the user. This device is typically a microphone, which may be integrated into the frame or housing of the system.

In certain embodiments, the memory stores an operating system, such as Android 11.0, and a main application. The main application, which may be written in languages like Java and Kotlin, implements the core functionalities and user interface of the system.

To facilitate communication, the system preferably comprises at least one connectivity module, configured to provide network connectivity using a standard protocol such as Wi-Fi (IEEE 802.11) or Ethernet (IEEE 802.3).

The system may also include an image database configured to store image data, such as the composite edited image, and generate unique identifiers for stored images.

The various hardware components are preferably encased within a single housing. In some embodiments, the housing comprises a frame, for example, a polyester or ABS frame surrounding the display screen.

The processor is responsible for executing the instructions that carry out the image creation and editing methods of the invention. The capabilities of the processor are preferably at least those of a quad-core processor in the 2.0 GHz class and supporting at least 2 GB of memory. Processor and memory may be integrated into a single System on Chip (SoC). Suitable examples of processors include but are not limited to the Rockchip RK3566, Rockchip RK3588, Qualcomm Snapdragon 6xx and 7xx series, MediaTek Helio G-series or Kompanio-series, and Apple A- and M-series. Suitable operating systems include Android, Windows, Linux, iOS and macOS.

### Software Implementation and Extensibility

The functionality of the system is enabled by its software architecture. The generative AI model used by the image generation component can be of various types. In one embodiment, the generative AI model comprises a diffusion model. Diffusion models are a class of generative models that can generate diverse, contextually coherent images from text prompts.

The system may operate in a hybrid client-cloud model. In some embodiments, the system retrieves the generative AI model from a cloud service, such as Amazon Web Services™ (AWS), Google Cloud Platform™ (GCP), or Microsoft Azure™. This allows the system to leverage powerful, up-to-date models hosted in the cloud without the need to have previously stored them on the device's local storage. By transparently selecting and implementing the best-suited AI model for each creating and editing task in real time, as a user is carrying them out, the system greatly accelerates the overall process of creating and editing digital images.

To foster an ecosystem of tools, the system can be designed as an extensible platform. In some embodiments, the system's instructions further cause the system to support execution of third-party applications through a JavaScript execution environment. These third-party applications may interact with the speech recognition component, the image region selection component, and the generative AI model through dedicated Application Programming Interfaces (APIs).

### Data Storage and System Updates

The instructions for performing the methods described herein may be stored by the device of the invention on a non-transitory computer-readable medium, such as an internal HDD, SSD, or other form of computer-readable storage.

One aspect of the invention is the provision within the device of a secure cryptoprocessor, such as a Trusted Platform Module (TPM) implementing the TPM 2.0 specifications, and associated memory. The TPM may reside in a dedicated chip soldered to the motherboard, or it may be implemented as a firmware-based module integrated into the CPU. The cryptoprocessor may be configured to verify that the system's boot process starts from a trusted combination of hardware and software. The system of the invention may be configured to encrypt artwork (the image bytes) and/or artwork-associated NFT keys using encryption keys securely stored in the TPM, and to store the resulting encrypted artwork and NFT key files in the non-transitory computer-readable storage medium. This enables a method for securely fixing the artwork to the hardware system, by storing only encrypted versions of the artwork file in the non-transitory computer-readable storage medium, thereby requiring the use of the securely stored encryption keys to produce a displayable image of the artwork. This, in turn, requires the physical presence of the specific Trusted Platform Module (TPM) that stores the key(s) used to encrypt an image file and/or NFT key.

To keep the device's capabilities current, the system may be configured to be updatable. In certain embodiments, the operations stored on the non-transitory computer-readable medium further comprise receiving an over-the-air (OTA) update comprising an updated generative AI model and storing the updated generative AI model in a local model database for subsequent use in generating replacement image segments. This OTA update mechanism allows for new models, features, and bug fixes to be delivered to the device over its network connection.

### EXAMPLES

The following examples are provided to further illustrate the disclosure and are not intended to be limiting in any way.

### Example 1: Method for Adding an Object to an Image

An initial digital image depicting a serene mountain landscape at sunrise is displayed on the system's 32-inch touch-sensitive display. A user performs a touch input by tapping a single finger on an empty area of the sky in the upper-left quadrant of the image. The processing system registers the (x, y) coordinates of this touch input. Immediately following the touch, the user speaks the voice command “add a soaring eagle” into the device's integrated microphone. The speech recognition component captures the audio input, processes it, and converts it into the text prompt: “add a soaring eagle”. The image region selection component then defines a 256×256 pixel bounding box centered on the registered touch coordinates. The image generation component transmits the text prompt and the original image data within the bounding box to a latent diffusion model. The generative AI model processes the inputs and generates a 256×256 pixel replacement image segment depicting a photorealistic eagle soaring against a sky that matches the color and lighting of the sky in the original sunrise landscape. The image merging component receives this new segment and algorithmically blends its edges with the surrounding pixels of the original landscape image, using a Poisson blending algorithm. Soon after the voice command is given, a composite edited image, now featuring the eagle soaring in the sky, is rendered on the touch-sensitive display.

### Example 2: Method for Modifying an Existing Object

A digital photograph of a classic red convertible car parked on a street is displayed. A user performs a touch-and-drag gesture over the body of the red car, selecting most of its painted surface. The user then speaks the voice command “make this car metallic blue”. The speech recognition component converts the audio to the text prompt “make this car metallic blue”. The image region selection component identifies a bounded area corresponding to the user's gesture, tightly masking the car's body. This bounded area, along with the text prompt, is sent to the image generation component. The generative AI model, using an in-painting technique, generates a replacement segment where the car is rendered in a metallic blue finish, while preserving the original lighting, reflections, and shadows from the surrounding environment. The image merging component integrates this new segment into the image. The resulting composite image, showing a metallic blue convertible parked on the same street, is displayed to the user.

### Example 3: Asynchronous Execution for UI Responsiveness

A user initiates a complex edit on an image of a dense forest. The user selects the entire forest area and gives the voice command, “turn this into a futuristic city with glowing towers”. The system begins processing this request. The image generation task is executed asynchronously on a background thread using Kotlin coroutines. While the generation is in progress, the user is able to access the system's settings menu via an on-screen icon or menu item, and adjust the display brightness. The user interface (UI) remains responsive because the main UI thread is not blocked by the ongoing AI inference task. Soon after, a notification appears, and a composite image comprising the futuristic city is displayed.

### Example 4: Over-the-Air (OTA) System Update

The device, while connected to the user's WiFi network, periodically checks a remote update server. The server indicates that a new firmware version is available, which includes an updated generative AI model, e.g. MindGallery-Gen-v2. The device displays a notification to the user, who accepts the update. The device downloads the update package in the background. Upon completion, the device installs the update, replacing the older MindGallery-Gen-v1 model in its protected memory space with the new MindGallery-Gen-v2 model. The next time the user performs an image edit, the system automatically uses the new model.

### Example 5: Image File Encryption

Following the creation of the composite image featuring the soaring eagle in Example 1, the user selects an on-screen “save encrypted” button. The processing system takes the full-resolution byte data of the composite edited image, encrypts it with a key stored in the Trusted Platform Module, and writes the encrypted file to the internal image database stored in the device's memory.

### Example 6: Creation of Interactive Video

A user issues a spoken request: “Create a learning animation video teaching me about monarch butterflies.” The AI model displays a touch-screen menu asking the user to select a short (1 scene) or long (5 scenes) animation. The user selects “long” and presses a “Next” button. An animated video is generated in which a “professor” character teaches about, inter alia, the butterflies'development from caterpillars, diet, and migration, with animated illustrations of each topic. After the video plays, multiple-choice questions about each topic (e.g., “How far can monarch butterflies migrate in one season?” are generated and presented sequentially on the touch-screen, as the user selects and submits his answers. The video concludes with suggestions for more detailed videos about related topics, such as “stages of metamorphosis” or “migration patterns,” which the user may select, resulting in the creation of further interactive content.

We claim:

1. A computer-implemented method for editing a digital image, the method comprising:
(a) receiving, by a processing system, an input that identifies a region of a displayed image;
(b) receiving, by the processing system, a voice input from an audio input device, wherein the voice input describes a desired modification for the identified region;
(c) converting, by a speech recognition component of the processing system, the voice input into a text prompt;
(d) identifying, by an image region selection component of the processing system, a bounded area of the displayed image corresponding to the identified region of the displayed image;
(e) selecting a generative AI model on the basis of the text prompt;
(f) retrieving the selected generative AI model from a generative AI model database;
(g) generating, by an image generation component of the processing system, a replacement image segment for the bounded area using the selected generative AI model;
(h) merging, by an image merging component of the processing system, the replacement image segment with the displayed image to produce a composite edited image; and
(i) displaying the composite edited image on a touch-sensitive display.

2. The method of claim 1, wherein the region is identified by spoken words.

3. The method of claim 1, wherein the region is identified by text input.

4. The method of claim 1, wherein the region is identified by touch input on a touch-sensitive display.

5. The method of claim 4, wherein the bounded area is represented as one or more bounding boxes defined by coordinates derived from the touch input.

6. The method of claim 1, wherein the generative AI model database resides on a cloud service.

7. The method of claim 1, wherein the generative AI model database is a local model database.

8. The method of claim 1, wherein converting the voice input into the text prompt comprises processing analog audio data captured by a microphone integrated with the touch-sensitive display.

9. The method of claim 1, wherein merging the replacement image segment with the displayed image comprises algorithmically blending the replacement image segment with the displayed image to produce a seamless composite edited image.

10. The method of claim 1, further comprising storing the composite edited image in an image database and generating a unique identifier associated with the composite edited image.

11. The method of claim 10, wherein, prior to storage in the image database, the composite edited image is encrypted with a key stored in a Trusted Platform Module.

12. The method of claim 1, further comprising executing the converting, identifying, generating, and merging operations asynchronously using coroutines, to maintain responsiveness of a user interface rendered on the touch-sensitive display.

13. A dedicated system for editing a digital image, the system comprising:
(a) a touch-sensitive display configured to display an image;
(b) an audio input device configured to capture a voice input;
(c) a processor; and
(d) a memory storing instructions that, when executed by the processor, cause the system to:
(i) convert the voice input into a text prompt using a speech recognition component;
(ii) identify a bounded area of the displayed image using an image region selection component;
(iii) select a generative AI model on the basis of the text prompt; and
(A) if the selected generative AI model is available in a local model database, retrieve the model from the local storage device; otherwise,
(B) dynamically load the selected generative AI model from a remote server and store the selected generative AI model in the local model database;
(iv) generate, by an image generation component of the processing system, a replacement image segment for the bounded area using the selected generative AI model;
(v) merge the replacement image segment with the displayed image to produce a composite edited image; and
(vi) render the composite edited image on the touch-sensitive display.

14. A dedicated system for creating digital video, the system comprising:
(a) a touch-sensitive display configured to display digital video;
(b) an audio input device configured to capture voice input;
(c) a processor; and
(d) a memory storing instructions that, when executed by the processor, cause the system to:
(i) convert the voice input into one or more text prompts using a speech recognition component;
(ii) receive an initial frame, or if no initial frame is received, create an initial frame based upon at least one of the text prompts;
(iii) generate a digital video from the initial frame using the text prompts and a generative AI video model; and
(iv) render the created digital video on the touch-sensitive display.

15. The dedicated system of claim 13, further comprising a connectivity module configured to provide network connectivity using one or more of Wi-Fi, Ethernet, or Bluetooth.

16. The dedicated system of claim 13, further comprising a computer-readable storage medium having stored therein an image database configured to store image data and generate unique identifiers for stored images.

17. The dedicated system of claim 16, further comprising a trusted platform module (TPM), and further configured to store the image data in encrypted form, using cryptographic keys secured stored in the TPM.

18. The dedicated system of claim 13, wherein the instructions further cause the system to support execution of third-party applications through a JavaScript execution environment, wherein the third-party applications interact with the speech recognition component, the image region selection component, or the generative AI model through JavaScript APIs.

19. The dedicated system of claim 13, further comprising a housing encasing the touch-sensitive display, the audio input device, the processor, the memory, and a computer-readable storage medium having stored therein the local model database.

20. The dedicated system of claim 16, further comprising a housing encasing the touch-sensitive display, the audio input device, the processor, the memory, the computer-readable storage medium having stored therein the local model database, and the computer-readable storage medium having stored therein the image database.

21. A non-transitory computer-readable medium storing instructions that, when executed by a processor, cause the processor to perform operations comprising:
(a) receiving, by a processing system, an input that identifies a region of a displayed image;
(b) receiving, by the processing system, a voice input from an audio input device, wherein the voice input describes a desired modification for the identified region;
(c) converting, by a speech recognition component of the processing system, the voice input into a text prompt;
(d) identifying, by an image region selection component of the processing system, a bounded area of the displayed image corresponding to the identified region of the displayed image;
(e) selecting a generative AI model on the basis of the text prompt;
(f) retrieving the selected generative AI model from a generative AI model database;
(g) generating, by an image generation component of the processing system, a replacement image segment for the bounded area using the selected generative AI model;
(h) merging, by an image merging component of the processing system, the replacement image segment with the displayed image to produce a composite edited image; and
(i) displaying the composite edited image on a touch-sensitive display.

22. The non-transitory computer-readable medium of claim 21, wherein the operations further comprise:
(j) receiving an over-the-air update comprising an updated generative AI model; and
(k) storing the updated generative AI model for subsequent use in generating replacement image segments.
